(19) United States
(12) Patent Application Publication
(10) Pub. No.: US 2003/0236723 A1
(43) Pub. Date: Dec. 25, 2003

(54) Automatic billing system for a lawn mowing service using GPS

(76) Inventor: Paul G. Angott, Bloomfield Hills, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/179,558

(22) Filed: Jun. 25, 2002

(51) Int. Cl. G06F 17/60

(52) U.S. Cl. 705/34

(57) ABSTRACT

A global positioning satellite receiver (14) is disposed on a lawnmower (10) for determining the geographical location of the lawn (12) by communicating with one or more satellites (16). A programmer (18) stores an account code and address for the lawn (12) location. A location transmitter (20) is disposed on the lawnmower (10) for transmitting the location from the lawnmower (10) to the programmer (18). The combination is characterized by including a statement generator (22) driven by the programmer (18) for generating a billing statement in response to a predetermined number of cuttings of the lawn (12). The billing statement is sent via mail, regular or email.

### BACKGROUND OF THE INVENTION

1. Field of the Invention

The invention relates to a billing system for cutting lawns or otherwise periodically traversing a plot of land with a machine wherein the pattern of traverse is programmed and guided by a global positioning satellite (GPS).

2. Description of the Prior Art

The prior is replete with machines that follow pre-programmed paths and that navigate via GPS. In this category are numerous systems for guiding a lawnmower over a lawn for cutting the lawn. With the advent of automatic lawnmowers and their use by lawn mowing services, there remains a need for further automation of the method of delivering such services.

### SUMMARY OF THE INVENTION AND ADVANTAGES

Accordingly, the invention provides a method comprising the steps of traversing a geographical plot with a machine, communicating with a positioning system from a transceiver on the machine to determine the geographical location of the plot, and transmitting the location from the transceiver to a programmer. These steps are combined with the steps of assigning an account code to the location, assigning a billing address for the location, transmitting from the transceiver to the programmer upon each occurrence of traversing the plot with the machine, generating a billing statement in response to a predetermined number of traverses of the plot, and sending the billing statement to the billing address.

The method is performed by an assembly that includes a machine for traversing the plot, a positioning receiver on the machine for determining the geographical location of the plot, a programmer for storing an account code and address for the plot location, a transmitter for transmitting the location from the machine to the programmer, and a statement generator for generating a billing statement in response to a predetermined number of traverses of the lawn.

### BRIEF DESCRIPTION OF THE DRAWINGS

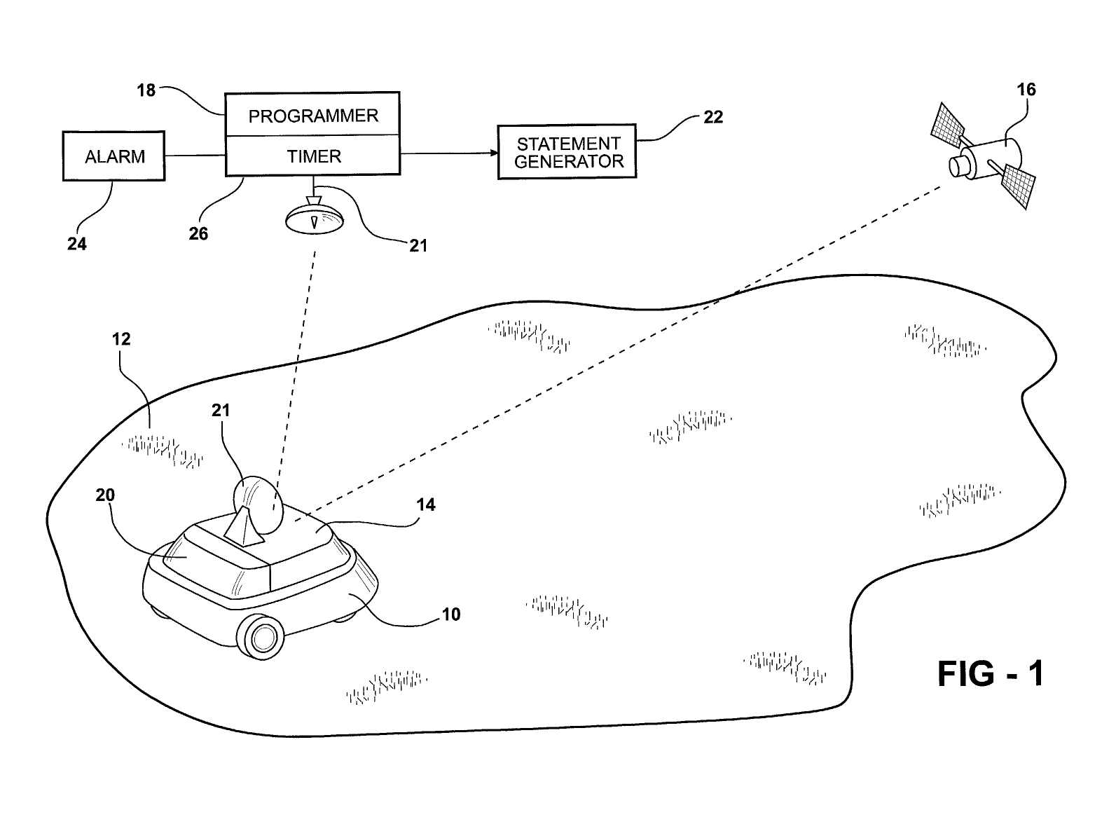

Other advantages of the present invention will be readily appreciated as the same becomes better understood by reference to the following detailed description when considered in connection with the accompanying drawings wherein FIG. 1 is a schematic view of the subject invention.

### DETAILED DESCRIPTION OF THE PREFERRED EMBODIMENT

Referring to the Figures, wherein like numerals indicate like or corresponding parts throughout the several views, a method and assembly for mowing a lawn and billing therefor is shown schematically in FIG. 1.

The assembly for mowing a lawn and billing therefor includes a machine 10 or lawnmower 10 for traversing a plot, e.g., cutting a lawn 12. A global positioning satellite receiver 14 is disposed on the lawnmower 10 for determining the geographical location of the lawn or plot 12 by communicating with one or more satellites 16. Alternatively, the positioning system may comprise a laser system as disclosed in U.S. Pat. No. 5,426,584 or the radio frequency systems shown in U.S. Pat. Nos. 5,911,670 and 6,009,358.

The assembly includes a programmer 18 for storing an account code and address for the lawn 12 location. This may be in the form of an account number and a street address or other mailing or email address. The programmer may store the identification of the plot so that the operator inserts or picks the location from the memory of the programmer. A location transmitter 20 is disposed on the lawnmower 10 for transmitting the location from the lawnmower 10 to the programmer 18. The transceiver 14, 20 and the programmer 18 include antennas 21 for establishing the radio transmission of signals.

Also included is a statement generator 22 driven by the programmer 18 for generating a billing statement in response to a predetermined number of cuttings of the lawn 12, one or more, depending upon the billing frequency.

Accordingly, the invention provides a method comprising the steps of cutting a lawn or plot 12 with the lawnmower 10, or traversing the plot 12 with another machine, communicating with the global positioning satellite 16 from the transceiver 14, 20 on the lawnmower 10 to determine the geographical location of the lawn 12, and transmitting the location from the transceiver 14, 20 to the programmer 18. These steps are combined with the steps of assigning an account code to the location, assigning a billing address for the location, transmitting from the transceiver 14, 20 to the programmer 18 upon each occurrence of cutting the lawn 12 with the lawnmower 10, generating 22 a billing statement in response to a predetermined number of cuttings of the lawn 12, and sending the billing statement to the billing address. The programmer 18 assigns the account code and registers the address. The programmer keeps track or memorizes the mowing of the lawn 12 by date, time of start and finish, and cutting pattern. By programming a cutting pattern for the lawn 12 and memorizing the pattern, an alarm 24 can be generated in response to the lawnmower 10 deviating from the programmed pattern. As alluded to, the programmer 18 includes a timer 26 for recording the period of time for mowing the lawn 12.

As will be appreciated, the method may include cutting a plurality of lawns 12 with the same lawnmower 10, transmitting from the transceiver 14, 20 to the programmer 18 upon each occurrence of the cutting of each lawn 12, generating 22 a separate billing statement for each lawn 12 in response the cutting of each lawn 12, and sending the billing statements to the respective billing addresses. In addition the method may include the steps of cutting a plurality of lawns 12 with a plurality of lawnmowers 10, transmitting from the transceiver 14, 20 of each lawnmower 10 to the programmer 18 upon each occurrence of cutting each lawn 12, generating 22 a separate billing statement for each lawn 12 in response to the cutting of each lawn 12, and sending the billing statements to the respective billing addresses.

Obviously, many modifications and variations of the present invention are possible in light of the above teachings. The invention may be practiced otherwise than as specifically described within the scope of the appended claims, wherein that which is prior art is antecedent to the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the incentive novelty exercises its utility. In addition, the reference numerals in the claims are merely for convenience and are not to be read in any way as limiting.

What is claimed is:

1. A method of mowing a lawn (12) and billing therefor comprising the steps of;
cutting a lawn (12) with a lawnmower 10,
communicating with a positioning system (16) from a transceiver (14, 20) on the lawnmower (10) to determine the geographical location of the lawn (12),
transmitting the location from the transceiver (14, 20) to a programmer (18),
assigning an account code to the location,
assigning a billing address for the location,
transmitting from the transceiver (14, 20) to the programmer (18) upon each occurrence of cutting the lawn (12) with the lawnmower (10),
generating (22) a billing statement in response to a predetermined number of cuttings of the lawn (12), and
sending the billing statement to the billing address.

2. A method as set forth in claim 1 including cutting a plurality of lawns (12) with the same lawnmower (10), transmitting from the transceiver (14, 20) to the programmer (18) upon each occurrence of the cutting of each lawn (12), generating (22) a separate billing statement for each lawn (12) in response the cutting of each lawn (12), and sending the billing statements to the respective billing addresses.

3. A method as set forth in claim 1 including cutting a plurality of lawns (12) with a plurality of lawnmowers (10), transmitting from the transceiver (14, 20) of each lawnmower (10) to the programmer (18) upon each occurrence of cutting each lawn (12), generating (22) a separate billing statement for each lawn (12) in response to the cutting of each lawn (12), and sending the billing statements to the respective billing addresses.

4. A method as set forth in claim 1 including programming (18) a cutting pattern for the lawn (12).

5. A method as set forth in claim 3 including generating an alarm (24) in response to the lawnmower (10) deviating from the pattern.

6. A method as set forth in claim 1 recording (26) the period of time for mowing the lawn (12).

7. A method comprising the steps of;
traversing a geographical plot (12) with a machine (10),
determining the geographical location of the plot (12),
transmitting the location from the transceiver (14, 20) to a programmer (18),
assigning an account code to the location,
assigning a billing address for the location,
transmitting from the transceiver (14, 20) to the programmer (18) upon each occurrence of traversing the plot (12) with the machine (10),
generating (22) a billing statement in response to a predetermined number of traverses of the plot (12), and
sending the billing statement to the billing address.

8. An assembly for mowing a lawn (12) and billing therefor comprising;
a lawnmower (10) for cutting a lawn (12),
a positioning receiver (14) on the lawnmower (10) for determining the geographical location of the lawn (12),
a programmer (18) for storing an account code and address for the lawn (12) location,
a transmitter (20) for transmitting the location from the lawnmower (10) to the programmer (18), and
a statement generator (22) for generating a billing statement in response to a predetermined number of cuttings of the lawn (12).

9. An assembly for traversing a plot (12) and billing therefor comprising;
a machine (10) for traversing the plot (12),
a positioning receiver (14) on the machine (10) for determining the geographical location of the plot (12),
a programmer (18) for storing an account code and address for the plot (12) location,
a transmitter (20) for transmitting the location from the machine (10) to the programmer (18), and
a statement generator (22) for generating a billing statement in response to a predetermined number of traverses of the lawn (12).

10. An assembly as set forth in claim 9 including a timer (26) for timing the period of traversing the plot (12).
